(19) United States
(12) Patent Application Publication
(10) Pub. No.: US 2025/0283495 A1
(43) Pub. Date: Sep. 11, 2025

(54) BRACKET, SYSTEM AND METHOD FOR INTERCONNECTING FURNITURE PARTS

(71) Applicant: SISO A/S, Skovlunde (DK)

(72) Inventors: David Tomas Perelman, Skovlunde (DK); Amir El Safty, Skovlunde (DK)

(73) Assignee: SISO A/S, Skovlunde (DK)

(21) Appl. No.: 18/861,740

(22) PCT Filed: Apr. 26, 2023
(86) PCT No.: PCT/IB2023/054290

§ 371 Date: Oct. 30, 2024

(30) Foreign Application Priority Data
May 11, 2022 (DK) PA202200443

(51) Int. Cl. F16B 12/12

(52) U.S. Cl. CPC F16B 12/12

(57) ABSTRACT

The present invention relates to a bracket, system and method for interconnecting furniture parts. The bracket for interconnecting two furniture parts comprises a base and a wall element projecting from the base and for facing and interconnection with a similar second bracket arranged on a second furniture part. The wall element and the base define a channel configured to receive and interconnect with at least one wall element of the second bracket, the bracket further comprising a stop within the channel arranged at a central longitudinal position of the bracket for interacting with a similar stop on the second bracket.

### TECHNICAL FIELD

The present invention relates to a bracket, a system and a method for interconnecting furniture parts.

### BACKGROUND OF THE INVENTION

The technique of interconnecting elements such as furniture part in a releasable manner may be done with releasable fastening means such as screws, or by interconnecting brackets.

When using interconnecting brackets, a first “female” bracket part is mounted to a first furniture part and a second “male” bracket part is mounted to a second furniture part, whereafter the two brackets may be interconnected by a sliding motion from a first specific end of the typically elongated brackets toward the opposite end.

The “male” bracket is inserted into one end of a channel in the “female” bracket and may be inserted all the way into the channel until an end of the channel functions as a stop, preventing any further displacement between the two brackets. Such coupling between two furniture parts is simple and fast and provides the possibility of establishing an effective releasable coupling.

An example of prior art systems is disclosed in DE19941659A1. The system discloses a “male” and a “female” coupling as defined above, in which the two couplings may be engaged in a sliding motion. Another example of prior art is shown in D1, which discloses a bracket for interconnecting two furniture parts. The bracket is however constructed such that two brackets can only be inserted into each other from one direction, which limits the useability of the bracket.

However, the above defined system requires two differently shaped brackets, which increases manufacturing costs and requires increased attention when installing the brackets. Further, as the brackets can only be interconnected by a sliding motion in exclusively one specific direction, again special attention needs to be taken when installing the brackets, and the fixed direction of interconnection limits the possibilities of flexibility during installation.

It is therefore an object of the present invention to overcome the above-defined problems, and to arrange a bracket, a system and a method for interconnecting two elements, such as two furniture parts, by brackets, where the brackets can be interconnected from two directions by a sliding motion from both ends of the brackets, thereby increasing the flexibility.

It is a further object of the present invention to arrange a bracket which can be interconnected to another substantially identical bracket. Hereby the necessity of manufacturing two differently shaped brackets is avoided, whereby production costs are reduced.

The above object and advantages, together with numerous other objects and advantages, which will be evident from the description of the present invention, are according to a first aspect of the present invention obtained by:

A bracket for interconnecting two furniture parts, the bracket having a first and second end, and a base with a lower surface for facing and interconnection with a first furniture part and an upper surface, the bracket having at least one wall element projecting from the upper surface, and for facing and interconnection with an identical second bracket arranged on a second furniture part,
the at least one wall element and the base defining a channel configured to receive and interconnect with at least one wall element of the second bracket,
the bracket further comprising a fixed stop within the channel at a central longitudinal position of the bracket, for interacting with an identical stop on the second bracket, for preventing movement between the brackets beyond the stop, where the channel is open at the first and second end, such that the at least one wall element of said second bracket may be inserted into the channel from either end.

The bracket is preferably arranged from an aluminum or a steel alloy, but may also be manufactured from other suitable materials, such as plastic, etc. and arranged to be connected by suitable connection means, such as screws or projections, to individual furniture parts.

The bracket comprises a bottom surface for facing a furniture part, the bottom surface being arranged as a lower surface of a base, preferably formed as a substantially flat elongated plate element.

At least one wall element extends from a side edge of the base and projects from an upper surface, opposite the lower surface. In another embodiment, the bracket comprises two wall elements extending from the upper surface of the base element.

The wall element(s) and the base together define a channel, which is configured to receive and interconnect with at least one wall element of a second, preferably similar, bracket.

It is hereby possible to interconnect two different furniture parts in a simple way by using the same, or substantially the same type of two brackets.

By arranging the fixed stop at a substantially central longitudinal position, and preferably centrally longitudinal within the channel, the same type of bracket can be used in relation to two furniture parts, which, due to the centrally positioned stop, can be interconnected from two different mounting directions being co-parallel with the channel, hereby increasing the flexibility of the brackets.

The channel is open at the ends of the bracket. Hereby, it is possible to interconnect the brackets with a sliding motion between the brackets from both ends. As mentioned above, the possibility of providing an interconnection from two opposite directions increases the flexibility of the bracket.

Alternatively, the bracket may be arranged with an opening in the wall elements, such that the two brackets may first be inserted in one another in an overlapping manner in a direction perpendicular to the longitudinal direction of the channel, and thereafter further interconnected by a sliding motion in the longitudinal direction of the channel until the stop of each bracket engages. By arranging the possibility of an initial overlap, the installation height of the bracket is reduced, which can be necessary if only limited installation space is available.

In another alternative it is possible to arrange the bracket with “closed” ends of the channel, but with the same opening in the wall elements. In this alternative embodiment, the brackets must first be engaged in the overlapping manner, followed by the sliding motion. It is in this alternative embodiment not possible to engage the brackets from the ends, hereby providing a slightly less flexible bracket, but the two “closed” interconnected brackets provide a more uniform and closed appearance.

According to a further embodiment of the first aspect of the invention, the at least one wall element comprises a connection flange extending from the wall element at an upper end thereof, such that when the bracket has been connected to the second bracket, the connection flange prevents the brackets from being disengaged in a direction transverse in relation to a longitudinal direction of the channel.

At least one wall element of the bracket is provided with a flange extending from an upper end of the wall element and in a radial direction thereof, and preferably in a direction substantially parallel with the upper surface of the base.

The above-described stop arranged in the channel prevents further movement between two interconnected brackets in the longitudinal direction of the channel, and the flange(s) prevents movement between two interconnected brackets in a direction perpendicular to the longitudinal direction of the channel. When two brackets are interconnected, the flange(s) of each bracket abuts and functions as a “hook”, hereby preventing the brackets from being separated.

According to a further embodiment of the first aspect of the invention, the connection flange only spans part of a longitudinal direction of the bracket.

As described above, the wall elements may be arranged with an opening or openings toward the channel in a direction substantially perpendicular to the longitudinal direction of the channel, such that two brackets first are engaged in an overlapping manner before the final sliding and engaging motion. This opening(s) is arranged by the connection flange not spanning the entire length of the wall element(s).

According to a further embodiment of the first aspect of the invention, the stop is arranged on the connection flange and/or the wall element and/or the base, in the channel between the connection flange and the upper surface of the base.

The stop in the channel of each bracket is arranged between the upper surface of the base and a lower surface of the flange. The stop may thus be arranged entirely on the lower surface of the flange, the upper surface of the base, or the wall element between the surface of base and the flange.

The stop may however also be arranged in the transition between the wall element and the flange and/or the transition between the wall element and the base, or in a further embodiment spanning the entire distance between the flange and the upper surface of the base, and thus arranged on all three elements.

According to a further embodiment of the first aspect of the invention, an upper part of the at least one wall element comprises a concave shape.

The upper part of the at least one wall element is preferably arranged having a concave shape. Preferably, the lower surface of the connection flange(s) also has a concave shape. Arranging the upper part of the at least one wall element with a concave shape, and preferably also the lower surface of the connection flange(s), reduces the area of direct surface contact between two interconnected brackets and hereby reduces the friction between the two brackets.

Another technical effect achieved by arranging the concave shape(s) is that two brackets inserted into each other from the ends may be inserted in a slightly oblique angle in relation to the longitudinal direction of the channel.

According to a further embodiment of the first aspect of the invention, a lower surface of the connection flange has a downwards inclination in relation to the upper surface of the base.

The connection flange, which extends in a radial direction in relation to the wall element, and preferably in a direction substantial parallel with the base, has a lower surface facing the base, where the lower surface has a downwards inclination from the junction with the wall element and toward the base.

By arranging a lower surface of the connection flange with such downwards inclination it is possible to arrange the bracket with only one wall element and still being able to prevent movement of the two brackets in a direction perpendicular to the upper surface of the base and further a direction perpendicular to the longitudinal direction of the channel, but parallel with the plane of the upper surface of the base. Hereby, a most simple yet versatile bracket can be made.

According to a further embodiment of the first aspect of the invention, the bracket comprises a first wall element extending along a first side of the base, and a second wall element extending parallel with the first wall element towards an opposite second side of the base, the second wall element extending a shorter distance along the base compared to the first wall element.

The bracket preferably comprises two wall elements extending parallel in relation to each other. Hereby, the longitudinal channel is defined by the upper surface of the base and the two parallel wall elements, which increases the strength of the connection between the two brackets.

According to a second aspect of the present invention, the above objects and advantages are obtained by:
A system comprising two brackets according to any of the embodiments of the first aspect of the invention.

The above defined system, which comprises two of the described brackets, provides an arrangement which improves the connectability of two furniture parts in an easy and flexible manner.

According to a third aspect of the present invention, the above objects and advantages are obtained by:
A method for interconnecting two furniture parts, wherein the method comprising the following steps:
providing a system according to the second aspect of the invention,
arranging first and second brackets on first and second furniture parts,
engaging the brackets, and
connecting the brackets by a sliding motion in a longitudinal direction of the channel until the fixed stop on each bracket abuts and prevents further sliding movement of the brackets in the longitudinal direction.

The steps as defined above provide a method of interconnecting two furniture parts, where the brackets can be interconnected from two directions, which increases the flexibility of the bracket, and whereby only one type of bracket is necessary for the functioning of the system.

According to a further embodiment of the third aspect of the invention, wherein before the step of connecting the brackets by a sliding motion, the brackets are engaged partly overlapping in a direction substantially perpendicular to the longitudinal direction.

As previously described, the bracket may be arranged such that two brackets may first be engaged in an overlapping manner in a direction perpendicular to the longitudinal direction of the channel, and thereafter interconnected by a sliding motion until the stops of the two brackets engage. Hereby, the installation height of the bracket is reduced, which can be necessary if only limited installation space is available.

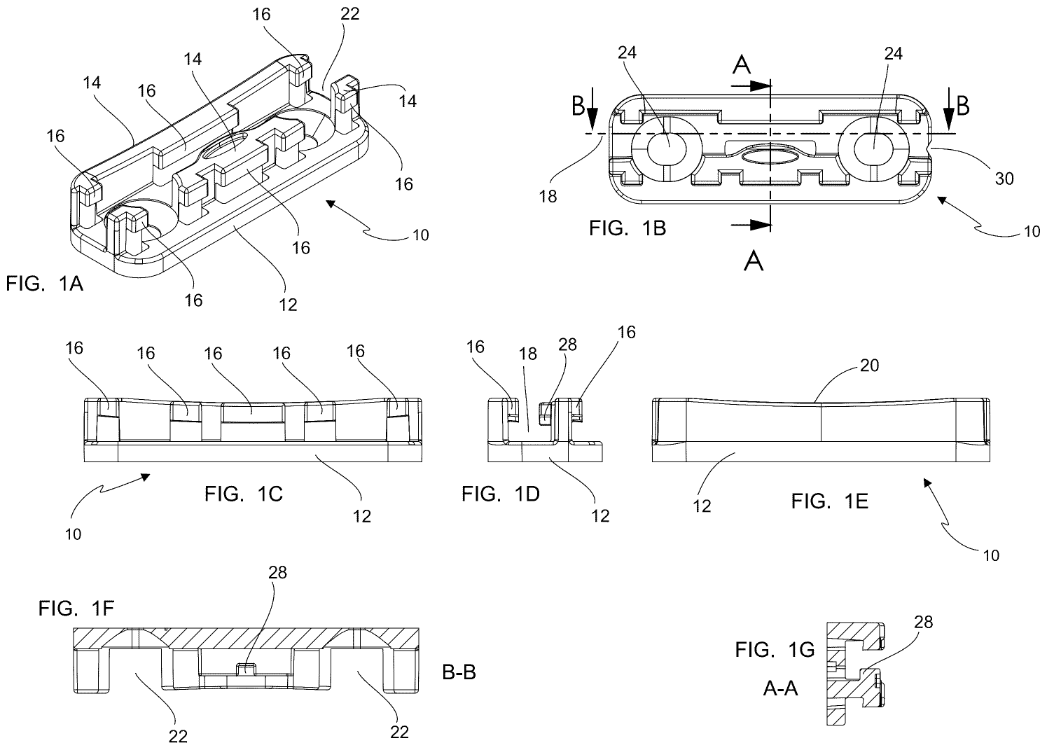

FIG. 1A is a perspective view of a first embodiment of the bracket.

FIG. 1B is a top view of a first embodiment of the bracket.

FIG. 1C-1E are side and end views of a first embodiment of the bracket.

FIG. 1F-1G are cross-sectional views of the first embodiment of the bracket.

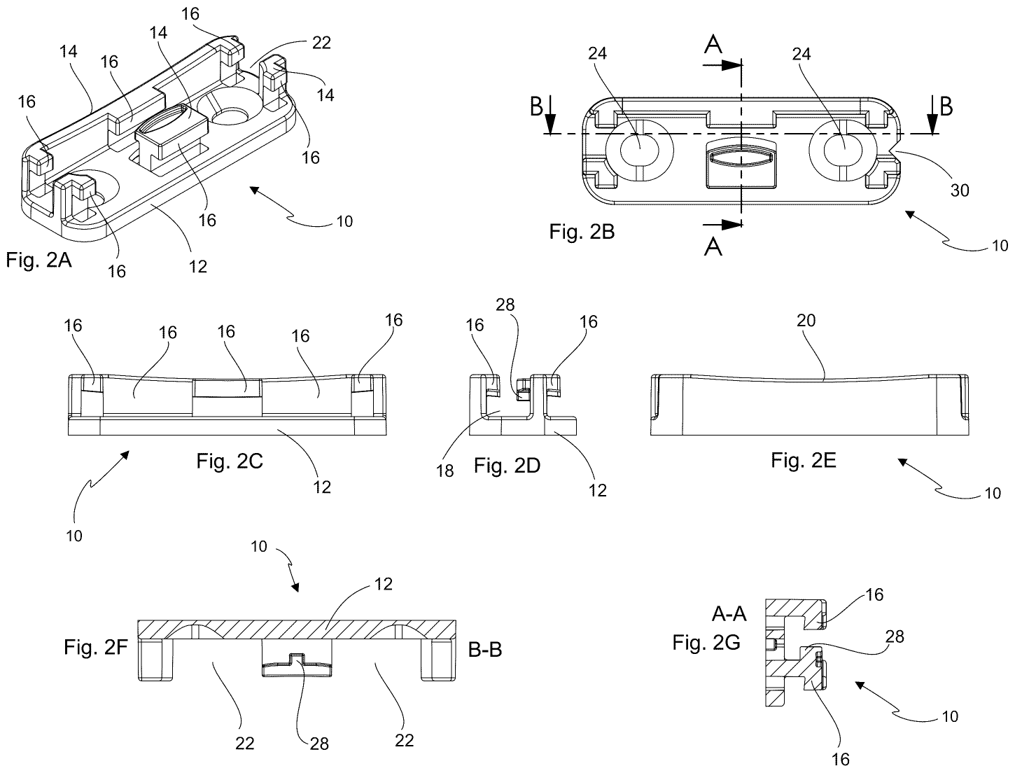

FIG. 2A is a perspective view of a second embodiment of the bracket.

FIG. 2B is a top view of a second embodiment of the bracket.

FIG. 2C-2E are side and end views of a second embodiment of the bracket.

FIG. 2F-2G are cross-sectional views of the second embodiment of the bracket.

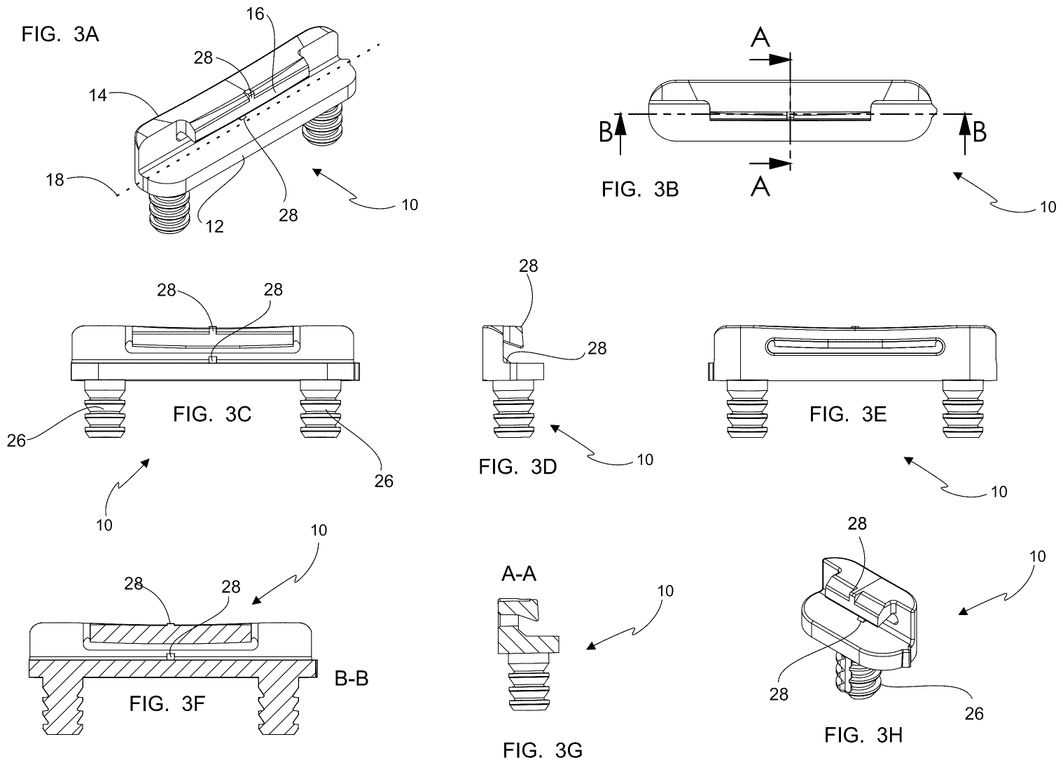

FIG. 3A and 3H are perspective views of a third and fourth embodiment, respectively, of the bracket.

FIG. 3B shows of a third embodiment of the bracket.

FIG. 3C-3E are side and end views of a third embodiment of the bracket.

FIG. 3F-3G are cross-sectional views of the third embodiment of the bracket.

FIG. 3H is a perspective view of a fourth embodiment of the bracket.

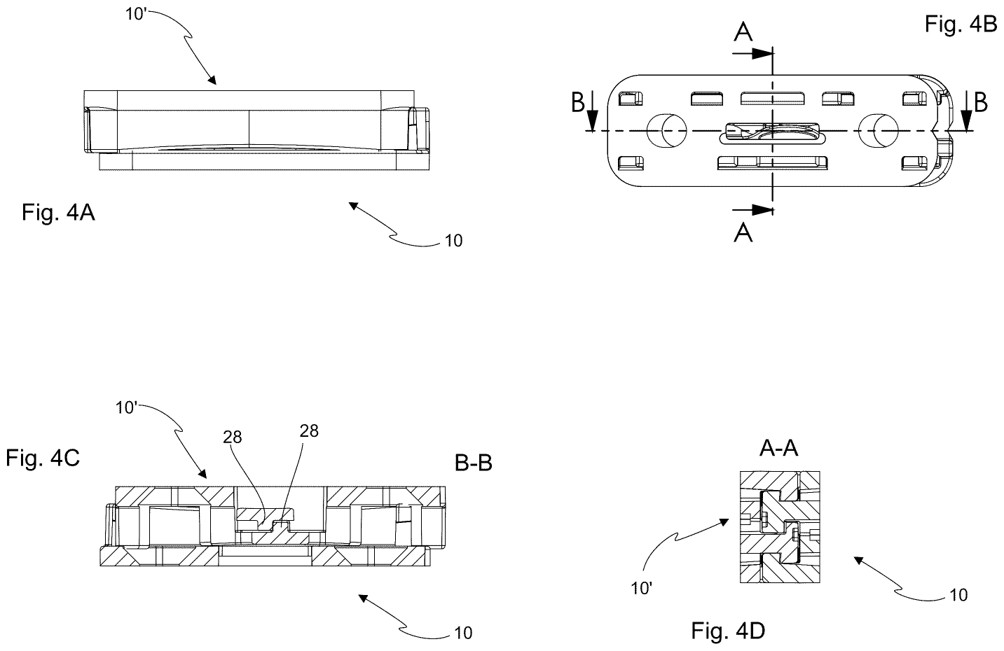

FIG. 4A-4B are a side and top view of two interconnected brackets of the first embodiment.

FIG. 4C-4D are cross-sectional views of the brackets shown in FIG. 4A-4B.

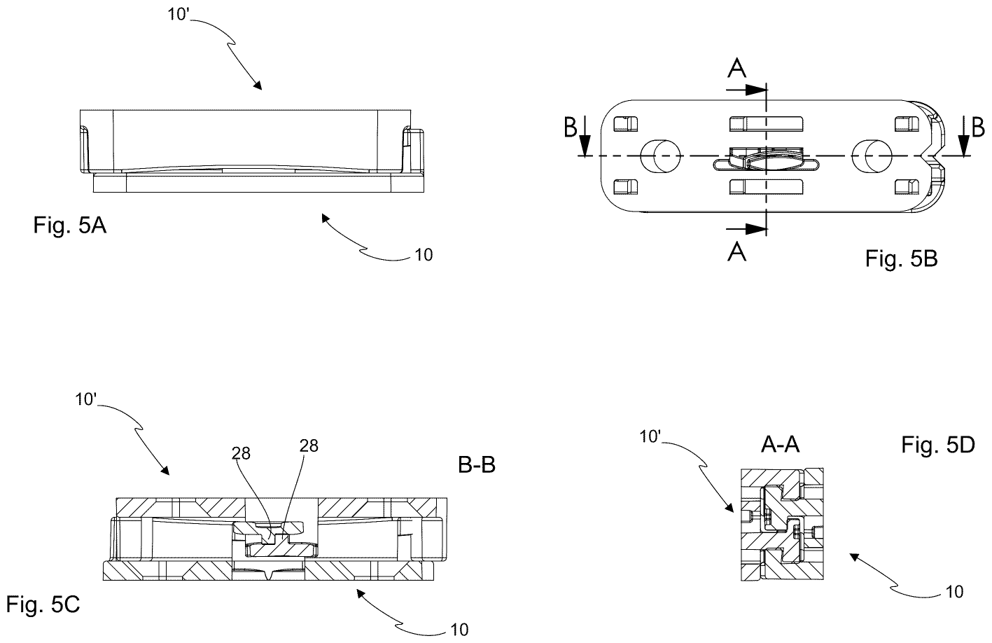

FIG. 5A-5B are a side and top view of two interconnected brackets of the second embodiment.

FIG. 5C-5D are cross-sectional views of the brackets shown in FIG. 5A-5B.

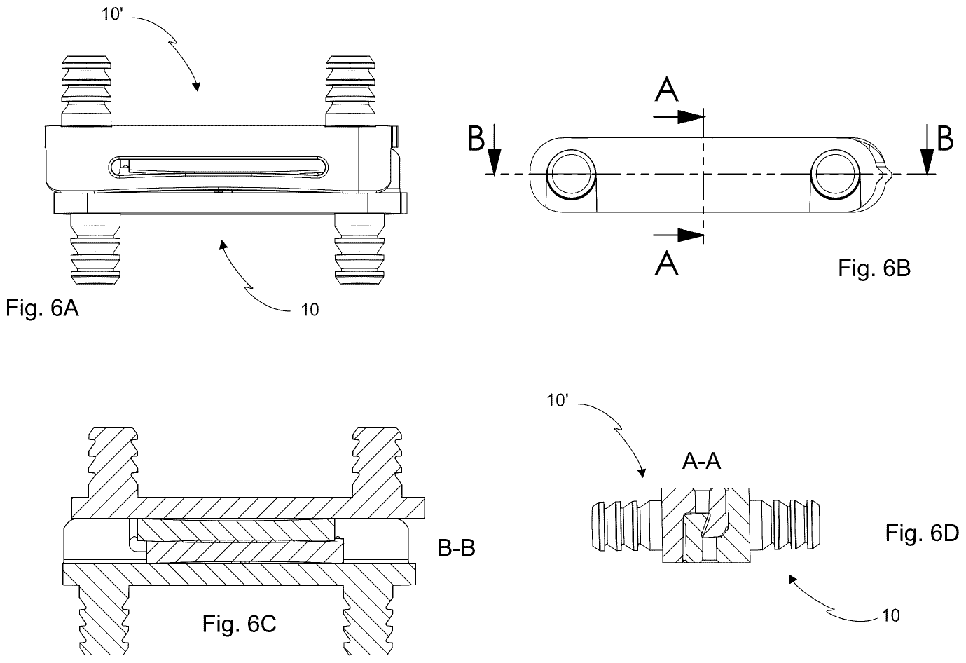

FIG. 6A-6B are a side and top view of two interconnected brackets of the third embodiment.

FIG. 6C-6D are cross-sectional views of the brackets shown in FIG. 6A-6B.

The present invention wilt now be described more fully hereinafter with reference to the accompanying drawings, in which exemplary embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout. Like elements will thus not be described in detail with respect to the description of each figure.

FIG. 1A and 1B show a perspective and a top view of a first embodiment of the bracket 10.

FIG. 1C-1E show side and end views of a first embodiment of the bracket 10, and FIG. 1F-1G show cross-sectional views of the first embodiment of the bracket 10.

The bracket 10 comprises a base 12 formed as a substantially flat elongated plate-like element having fixation holes 24 for fastening the bracket 10 to e.g., furniture parts by fixation means such as screws. The bracket 12 is shown elongated but may be arranged more rectangular or even in a roundish shape. The bracket 10 is shown with a first wall element 14 arranged at one side of the base 12 and spanning substantially the entire length of the base 12. The wall element may however be arranged shorter.

The bracket 10 further comprises second wall elements 14′ extending parallel with the first wall element 14 and in a spaced relationship thereto, such that the base 12 and the wall elements 14, 14′ define a channel 18 (see FIG. 1B and 1D).

The channel 18 is dimensioned such that a first wall element 14 of a second bracket 10′ can be arranged upside down within the channel 22.

The wall elements 14, 14′ are arranged with connecting flanges 16, which extend in a radial direction of the wall elements 14, 14′ and here shown extending in a direction substantially perpendicular to the upper surface of the base 12.

The connection flanges 16 are arranged such that when two brackets 10, 10′ are connected upside down, as described above, the connection flanges 16 mutual interconnect and prevent the brackets 10, 10′ from being disengaged in a direction perpendicular to the upper surface of the base 12.

As further illustrated in the figures, the connection flange 16 of the first wall element 14 are disrupted, and the bracket comprises two smaller opposite second wall elements 14′ arranged at opposite ends of the bracket 10 and a central second wall element 14′. This configuration allows two brackets 10, 10′ to be engaged overlapping in a direction perpendicular to the upper surface of the base 12 and thereafter slide into engagement with each other.

FIG. 1D, 1F and 1G show the central second wall element 14′ comprising a stop 28 arranged within the channel 22. This stop 28 engages with the stop 28 of a second bracket 14′ when the brackets 10,10′ are engaged upside down and slided into interconnection. Hereby any further movement in the slided direction is being prevented. In the shown embodiment only one stop is illustrated. However, the bracket may also, or alternatively, comprise stops 28 arranged elsewhere in the central position of the channel 22, such as in a central part on the first wall element 14 and on the central second wall element 14′ on the opposite side of the second wall element 14′, compared to the illustrated stop 28.

The embodiments shown in all further comprises a marking, arranged as a notch 30, such that the person installing the brackets 10 more easily may ensure that the individual brackets 10, 10′ are correctly positioned in relation to each other. The brackets 10,10′ may be arranged with different marking means, or no marking means at all.

The upper part of the wall elements 14 is arranged with a concave shape 20. As can be seen from FIG. 1C, the lower surface of the connection flanges 16 also has a concave shape. Arranging the upper part of the wall elements 14, and preferably also the lower surface of the connection flanges, with a concave shape reduces the area of direct surface contact between two interconnected brackets 10,10′ and hereby reduces the friction between the two brackets 10, 10′. A further technical effect achieved by providing the concave shape(s) is that two brackets 10, 10′ inserted into each other from the ends may be inserted in a slightly oblique angle in relation to the longitudinal direction of the channel 18.

FIG. 2A-2G show a perspective view, a top view, side and end views and cross-sectional views of a second embodiment of the bracket 10.

The embodiment of the bracket 10 shown in FIGS. 2A-2G is in the basic principle similar to the bracket 10 shown in FIGS. 1A-1G. However, as can be seen from the figures, the length of the second central wall element 14′ is smaller than the distance between the second central wall element 14′ and the two smaller second end wall elements 14′. By such configuration it is possible to engage the brackets in a more overlapping manner, compared to the embodiment shown in FIG. 1A-1G, which is particularly useful when the installation space is limited. Thereby, the brackets may be arranged shorter compared to the embodiment shown in FIG. 1A-1G.

FIG. 3A-3G show a perspective view, a top view, side and end views and cross-sectional views of a third embodiment of the bracket 10.

The bracket 10 comprises a base 12, which in principle corresponds to the base illustrated in the previous figures. The base is illustrated with fixation means 26, such as dowels, which ensures fast and easy fixation of the brackets 10 to the desired furniture parts. Alternatively, the bracket 10 may comprise fixation holes 24 as previously described. It should be noted that all embodiments disclosed may comprise fixation holes 24, dowels 26, or a combination thereof.

The bracket in this third embodiment comprises only one wall element 14 extending from the base 12. The wall element 14 comprises a connection flange 16 extending from the upper end of the wall element 14 and in a direction substantially parallel with the base 12 and forms a channel 18 extending in the longitudinal direction of the bracket.

As shown in FIG. 3D and 3G, the underside of the connection flange 16 comprises a surface which slopes downwards towards the base 12, and hereby forms a “hook-like” shape of the connection flange, such that when two brackets 10,10′ are brought into connection, the “hook” ensures that the brackets 10, 10′ are locked together in all directions perpendicular to the longitudinal direction of the channel 18 (see FIG. 6D).

As can also be seen from the figures, the length of the connection flange 16 is shorter than the length of the wall element 14. This ensures that two brackets 10, 10′ may be positioned overlapping before being interconnected by a sliding motion in the longitudinal direction of the channel 18. As previously disclosed, having the possibility of arranging the bracket overlapping, limits the need of installation space.

The bracket shown in the third embodiment comprises two stops 28. A first stop 28 being arranged on an upper surface of the flange element 16, and the second stop being arranged within the channel. Hereby, when two brackets 10,10′ are slidably connected, the first stop 28 of the first bracket 10 abuts against the second stop 28 of the second bracket 10′, and vice versa.

FIG. 3H shows a perspective view of a fourth embodiment of the bracket 10. The bracket 10 shown in FIG. 3H in principle corresponds to the bracket 10 shown in FIG. 3A-3G, but as can be seen, only comprises one fixation means 26, and may therefore be arranged as a much shorter bracket 10 if desired.

The brackets 10 shown in the embodiments in FIGS. 3A-3H may, due to the arrangement of only one wall element 14, be arranged more narrow compared to the embodiments shown in the previous figures.

FIGS. 4A-B, 5A-5B and 6A-6B show a side and top view of two interconnected brackets 10,10′ of the different embodiments.

FIGS. 4A, 5A and 6A all show side views of two fully interconnected brackets 10, 10′. The brackets 10, 10′ are substantial identical and when being fully interconnected, the brackets are displaced in relation to each other, as can be seen, by a distance corresponding to a width of the stop 28.

The views further illustrate the reduced friction between the two brackets 10, 10′ by the arrangement of the concave surfaces.

FIGS. 4B, 5B and 6B illustrate the embodiments shown in FIGS. 4A, 5A and 6A. The brackets 10,10′ are displaced in the longitudinal direction in relation to each other by a distance corresponding to the width of the stop. The two brackets 10,10′ are in the transverse direction due to the arrangement of the wall element(s) and the connection flange(s) 16 sideways aligned in relation to each other, which ensures an aligned mounting of the furniture parts.

FIGS. 4C-4D, 5C-5D and 6C-6D show cross-sectional views of the brackets shown in FIGS. 4A-B, 5A-5B and 6A-6B.

FIGS. 4C, 5C and 6C illustrate cross-sectional views along lines B-B of FIGS. 4B, 5B and 6B.

The figures show the brackets 10, 10′ of the different embodiments fully interconnected and clearly illustrate the displacement of the brackets due to the width of the stops 28.

FIGS. 4D, 5D and 6D illustrate the interconnection of the brackets 10, 10′ due to the arrangement of the base elements 12, the wall elements 14 and the connection flanges 16. As can be clearly seen, the brackets 10, 10′ are “locked” in relation to each other in all directions substantially perpendicular to the longitudinal direction of the channel 28 and slidably connected in the longitudinal direction of the channel until the stops 28 on each engage.

In the following is given a list of reference signs that are used in the detailed description of the invention and the drawings referred to in the detailed description of the invention.
10, 10′ Bracket
12 Base
14, 14′ Wall element
16 Connection flange
18 Channel
20 Concave upper part
22 Opening
24 Fixation hole
26 Fixation means
28 Stops
30 Notch

1. A bracket for interconnecting two furniture parts, the bracket having a first end and a second end, and a base with a lower surface for facing and interconnection with a first furniture part and an upper surface, the bracket having at least one wall element projecting from the upper surface, and for facing and interconnection with an identical second bracket arranged on a second furniture part,
the at least one wall element and the base defining a channel configured to receive and interconnect with at least one wall element of the second bracket, and
the bracket further comprising a fixed stop within the channel at a central longitudinal position of the bracket, for interacting with an identical stop on the second bracket, for preventing movement between the brackets beyond the stop, wherein the channel is open at the first and second end, such that the at least one wall element of the second bracket is inserted into the channel from either end.

2. The bracket according to claim 1, wherein the at least one wall element comprises a connection flange extending from the wall element at an upper end thereof, such that when the bracket has been connected to the second bracket, the connection flange prevents the brackets from being disengaged in a direction transverse in relation to a longitudinal direction of the channel.

3. The bracket according to claim 2, wherein the connection flange only spans part of a longitudinal direction of the bracket.

4. The bracket according to claim 2, wherein the stop is arranged on at least one of the connection flange, the wall element, or the base in the channel between the connection flange and the upper surface of the base.

5. The bracket according to claim 1, wherein an upper part of the at least one wall element comprises a concave shape.

6. The bracket according to claim 2, wherein a lower surface of the connection flange has a downwards inclination in relation to the upper surface of the base.

7. The bracket according to claim 1, wherein the bracket comprises a first wall element extending along a first side of the base, and a second wall element extending parallel with the first wall element towards an opposite second side of the base, the second wall element extending a shorter distance along the base compared to the first wall element.

8. A system comprising;
a bracket according to claim 1, and
the second bracket.

9. A method for interconnecting two furniture parts, the method comprising:
providing the system according to claim 8,
arranging first and second brackets the bracket and the second bracket on first and second furniture parts,
engaging the brackets, and
connecting the brackets by a sliding motion in a longitudinal direction of the channel until the fixed stop on each bracket abuts and prevents further sliding movement of the brackets in the longitudinal direction.

10. The method according to claim 9, wherein before said step of connecting the brackets by a sliding motion, the brackets are engaged partly overlapping in a direction substantial perpendicular to the longitudinal direction.
